(19) United States
(12) Patent Application Publication
(10) Pub. No.: US 2005/0028282 A1
(43) Pub. Date: Feb. 10, 2005

(54) Arrangement for fixation of a patient

(76) Inventors: Bo Magmai Tillander, Linkoping (SE); Lars Palm, Linkoping (SE); Ingemar Ivarsson, Linkoping (SE)

Correspondence Address: Gauthier & Connors LLP, Suite 3300, 225 Franklin Street, Boston, MA, 02110, US

(21) Appl. No.: 10/875,045

(22) Filed: Jun. 23, 2004

Related U.S. Application Data
(63) Continuation of application No. PCT/SE03/00078, filed on Jan. 20, 2003.

(30) Foreign Application Priority Data
Jan. 18, 2002 (SE) 0200125-3

(51) Int. Cl. A61G 13/12

(52) U.S. Cl. 5/624; 5/621

(57) ABSTRACT

The present invention relates to an arrangement for fixation of a patient prior to a surgical operation, like hip joint surgery, comprising support units applied against a pelvis, wherein at least one support unit comprises a support/compression applicable across the pelvis, when the pelvis is placed in a lateral decubitis position for exerting a vertically applied pressure (vertical power) and also for positioning a patient.

### TECHNICAL FIELD

Present invention relates to an arrangement for positioning a patient prior to a surgical operation, like hip joint surgery, comprising support units applied against a pelvis.

The purpose of present invention is to provide an arrangement by means of which a patient can be accurately positioned prior to a surgical operation for facilitate an accurate fitting in of a spare-part, such as a hip joint prosthesis.

### THE BACKGROUND OF THE INVENTION

To achieve a successful result at a hip joint surgery an accurately positioned and fixed patient is required. The demand for fixation is set when one prerequisite is correctly fixed and positioned patient to be able to orient the prosthesis correct in the patient having no other references but the room. An incorrect oriented prosthesis gives a poorer prosthesis function with an increased wear, increased risk that the prosthesis will come loose and also a risk that the prosthesis become dislocated. A rightly oriented prosthesis results in correct walk and reduced strain on remaining muscles, joints and skeleton parts.

At hip prosthesis surgery, hip prosthesis components are inserted by surgery which components are permanently fixed with bone cement in the patient. The position of the prosthesis components in relation to the skeleton is of decisive Importance for the function of the prosthesis.

If the patient does not lie positioned in a correct position one risks that the prosthesis components are inserted in a incorrect way, which results in a poorer function of the prosthesis.

The patient must be fixed in this position during the entire surgical operation, 2-4 hours, without thereby causing an Injurious pressure against the skin and bone prominences, which can result In ulcers.

An instrument for accurate adjusting of such components in itself has earlier (PCT/SE00/01474) been described, particularly for adjusting socket components, which forms one of the main parts of the hip prosthesis. Such an instrument Is of great help but in addition to that also an exact positioned patient Is required to be able to position the prosthesis components exactly.

During the surgery reference points are lacking and the surgeon is completely dependent on that the patient is correctly positioned and fixed to the operating-table, which positioning shall be done prior to the surgery begins. It is of great importance that the positioning can be done as accurate as possible. The patient shall be in a lateral decubitis position with the pelvis laterally and the longitudinal axis of the patient in parallel to the operating-table. The patient shall be fixed in such a position during the entire surgery (about 2 hours) without causing injurious pressure on skin and bone components, which in itself can cause ulcers.

Systems for positioning of a patient available today, do not meet the demand for an exact positioning, good pressure distribution and a simple handling.

All such systems are based on some form of support/compression being applied against the pelvis from the front and from behind, that Is, on the abdominal side and on the back side. This can give a certain fixation if the patient is very thin so that the bone prominences at the front of the pelvis are well defined. This does, however, come about on expense of a large local pressure on these prominences with accompanying risk of pressure injuries. Positioning of the thin patient is at the best difficult and is done Instinctively while it on the whole is very difficult to get any positioning when it comes to a fat people. The support of today often causes pressure against the abdomen as well, and not against the pelvis, which besides local discomfort also can give negative effects by means of pressure increase inside the abdomen with a risk of deteriorated breathing functioning and vomiting.

U.S. Pat. No. 3,844,550 describes a pelvis support to be arranged across an operating-table, the support comprising a first support to be applied against the back and a second support to be applied against a abdominal region, which second support can be displaced in such a way that the support can be pressed against the prominences of the pelvis bone. Any positioning with regard to the entire body is not obtained since the body can be bend around the second support.

U.S. Pat. No. 5,390,383 describes a front pelvis support complemented with a chest support placed on both sides of the patients body, which allows that the body can not be bend forwards over the hip region.

DE-C-3,436,197 describes a fixation support for hip joint operations comprising two upholstered backrests to be applied partly against the upper part of the spine, partly against the lower part of the spine. Any correct positioning of pelvis and hip joint part is not obtained herewith, but possibly a fixation of the body depending on which support the patient receives on the abdominal side.

DE-A-2,814,178 describes a operating-table with two raised supports for applying onto the back and abdominal side, respectively, of the pelvis region of the patient and with a lower plate for receiving a patients lower legs, at placing in a lateral decubitis position, and a upper, raiseable plate for receiving a patients upper legs, at placing in a lateral decubitis position.

Systems available are moreover by means of their design and placing on the operating-table causing certain trouble to surgeons from an ergonomic point of view, as well.

### DESCRIPTION OF PRESENT INVENTION

It has now been shown possible to reach a substantially much better stabilization by means of present invention which is characterized in, that at least one support unit comprises a support/compression, applicable across the pelvis, when the pelvis is placed in a lateral decubitis position for exerting a vertically applied pressure (vertical power).

Further characteristics will be seen from the enclosed claims.

By means of the present invention it is achieved that a large abdominal volume does not make positioning and fixation more difficult to the same extent as in known systems, discomfort, effect on the breathing and risk of vomiting is avoided since the abdomen is not exposed to pressure, makes possible the use of formable cushions which by means of pressure changes becomes stable and distributes the pressure from the fixation over a larger surface, which decreases the risk of pressure injuries, that the arrangement is more ergonomically placed onto the operating-table, that the exact vertical position by means of a level of the patients pelvis simply can be measured as the patients front side is not covered by the fixation, and that the arrangement easily can be applied onto existing operating-tables.

According to one preferred embodiment the support against the lateral part of the pelvis comprises at least one applied hip cushion arranged to be stretched in a vertical direction against a pelvis and preferably, the support comprises a lower and a upper hip cushion.

According to another preferred embodiment the lower hip cushion is divided into two parts and displaceably arranged between said two parts.

According to yet another preferred embodiment a vertically displaced, fixable stand is arranged to give a vertically, across the pelvis applied support/compression, when the pelvis is in a lateral decubitis position, at which the vertically displaceable stand preferably comprises an intermediate part arranged to abut against an upper hip cushion and preferably said middle part is bent at an angle and, preferably, the vertically displaceable stand comprises two fixable legs.

According to another preferred embodiment the vertically working support units are arranged to be stretched against the pelvis by means of a at least one strap.

According to a further embodiment of the invention the arrangement is arranged to a carrier, arranged to be fixed to an operating-table.

According to a further aspect of the invention it comprises a method for positioning a patient prior to a surgical operation for vertical positioning of said patients pelvis, a vertical pressure being applied across the pelvis, as the pelvis is in a lateral decubitis position.

According to a preferred embodiment of the method at least one support in form of a hip cushion is applied against the patients iliac.

According to another preferred embodiment of the method at least one vertically displaced, fixable means is arranged to practise said vertical pressure.

According to a further embodiment of the method at least one strap is arranged to provide said vertical pressure.

The present invention will be further described below with reference to the enclosed drawing which shows some preferred embodiments of the invention without being limited there to. In the drawing,

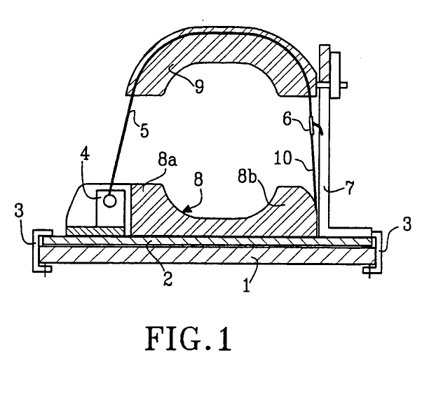

FIG. 1 shows a lateral view of an arrangement according to present invention,

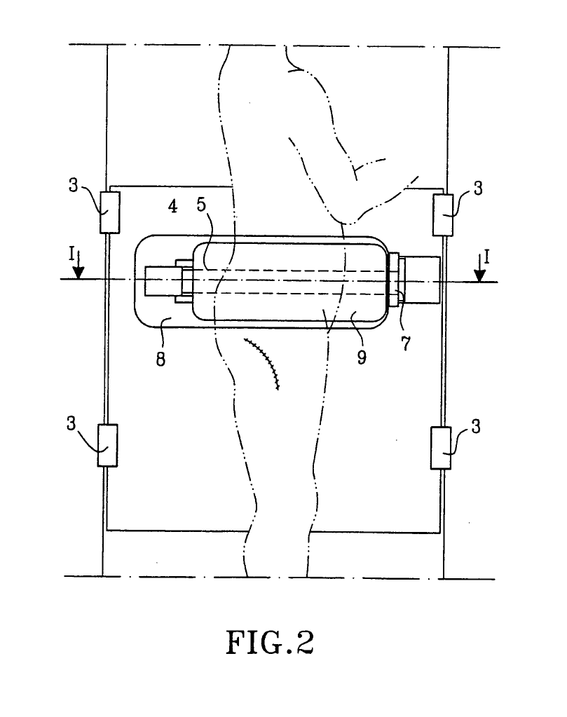

FIG. 2 shows a front view of the arrangement according to FIG. 1, in combination with a patient,

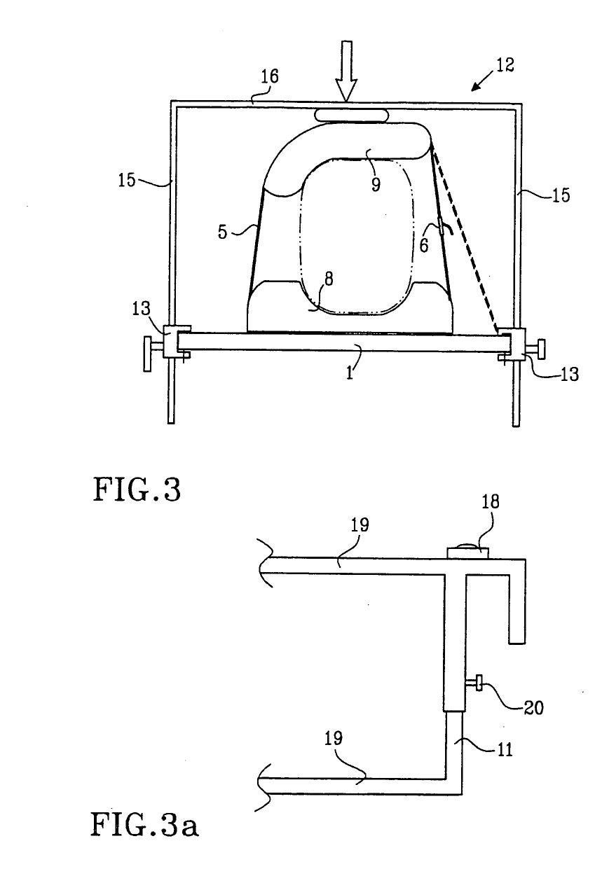

FIG. 3 shows a sectional view of a second arrangement according to the present invention together with a simple measuring device for vertical determination,

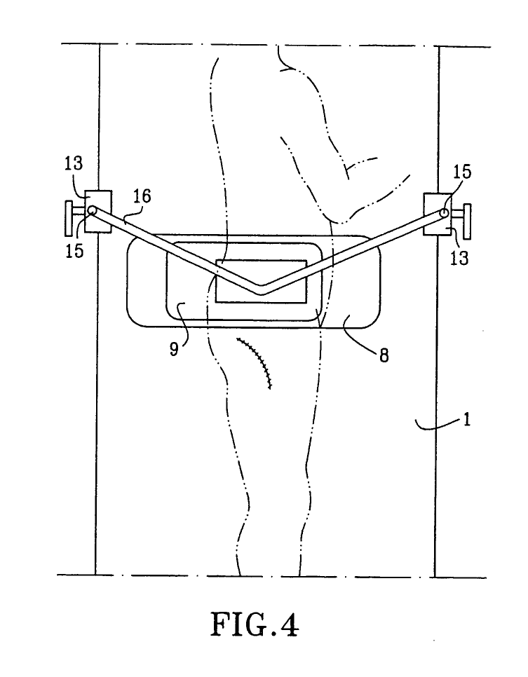

FIG. 4 shows a view from above of a further arrangement,

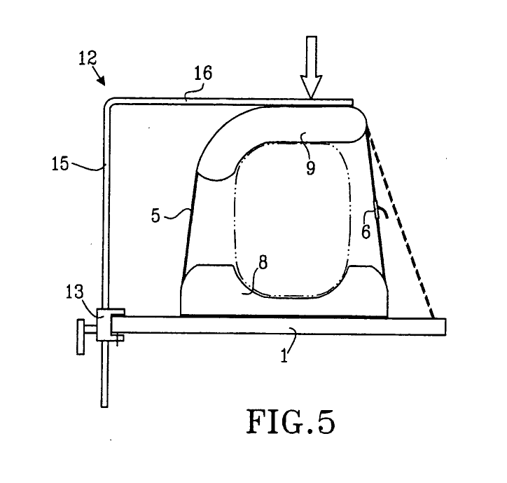

FIG. 5 shows a lateral view of yet another arrangement according to present invention,

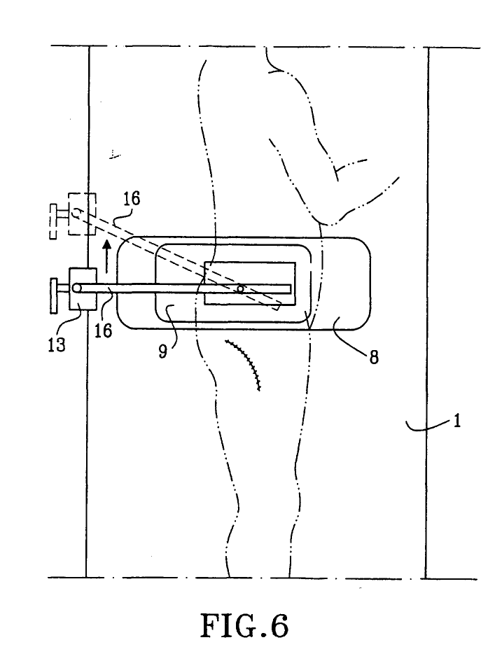

FIG. 6 shows a view from above of the arrangement according to FIG. 5 in combination with a patient.

In FIG. 1 an operating-table 1 is shown in a cross-section perpendicular to its longitudinal axis, to which operating-table a carrier 2 have been connected by means of four clamps 3 have been coupled. The carrier 2 comprises a rear attachment 4 from which a strap 5 leads over to the front side of the arrangement and to a stretching means 6 contained in a stand 7 attached to the carrier 2. Further a divided hip cushion 8 is arranged onto the carrier 2, which cushion 8 is arranged to receive a patients lower hip part in a lateral decubitis position. For this purpose, the hip cushion Is also placed substantially perpendicularly the longitudinal direction of the operating-table. The two parts 8a, 8b of the hip cushion 8 are arranged to be displaced relative to each other for adaptation of the best support to the patient placed In lateral decubitis position on this lower divided hip cushion 8. The strap 5 runs through a second hip cushion 9, which further is arranged to be attached to the stand 7 by means of second strap 10.

The hip cushions 8, 9 may consist of foam plastic material, which, from hygienic reasons, are covered by a sterilized cloth, a polyurethane foam material, also covered, which material Is adapted to the contour of the body by means of heat of the body and in such a way the patients body will become further stabilized, or a vacuum adjustable material consisting of a cover filled with particulate polymeric material, which, when the cover after adjustment as hip cushion, is connected to a vacuum source, the hip cushion being adapted entirely to the patients body, becomes shape-stable and thereof further increases the stability. Such a cushion which works under vacuum, is in this application called a vacuum cushion. Prior to applying vacuum the cushion acts like a normal cushion. A product with this design is sold under the name Germa Protec.

In one embodiment using of a vacuum cushion, the cushion runs from the lower side in a lateral decubitis position to the upper side behind the back and when vacuum is applied the pressure will be distributed over the pelvis and partially over the lumbar region. In the latter embodiment it has turned out to that the use of straps is not necessary.

In FIG. 2 the arrangement according to FIG. 1 is shown from above with a patient in place. As will be seen the patient is placed in such a way that both hip cushions 8, 9 are applied against the upper edge of the pelvis, the Iliac. When positioning the strap 5 is tightened, whereby a vertical power (a vertical pressure) is exerted onto the pelvis via the upper hip cushion 9 and with a counter force from the carrier 2 via the lower hip cushion 8. The strap 5 is locked in a locking device 6 (FIG. 1). In order to increase the comfort a support unit is provided In the lower part of the carrier 2 particularly for supporting the lower legs.

Even in this embodiment a vacuum cushion can be used according to above.

FIGS. 3 and 4 show a more simple embodiment of the embodiment according to the present invention comprising a lower hip cushion 8, a strap 5 and a upper hip cushion 9 and also a vertical displaceable stand 12 which is arranged to the carrier 2 via lockable attachments 13. The upper hip cushion 9 hereby also comprises a pressure plate 14 against which the vertically displaceable stand 12 is arranged to abut. After the patient has been placed the stand is pressed vertically downwards and is locked in its attachments 13.

By means of this pressing down of the stand 12 a vertical pressing down is exerted against the patients pelvis via the middle part of the stand, the pressure plate 14 and the hip cushion 9. The cushions 8, 9 are also locked by means of the strap 5 in a locking device 6. The stand 12 should suitably comprise two vertical legs 15 and an Intermediate part 16, whereby this intermediate part 16 further suitably is bent at an angle In order to, In this way, displace the stand 12 from the surgeon and increase the accessibility. In FIG. 3 a single jig 17 is also shown to be applied against the pelvis prominences, whereby a libel 18 arranged on the jig 17 denotes when these prominences are in a vertical position over each other. The jig 17 comprises two arms 19, which are displaceable relative to each other by means of a telescopic axis 11 and can be locked In a suitable position and at a distance from each other by means of a locking 20. In FIG. 4 the placing of a surgical incision in connection to a hip joint operation is also shown.

Even in this embodiment a vacuum cushion can be used according to above.

FIG. 5 and FIG. 6 show an arrangement similar to that one in FIG. 3 and FIG. 4, but wherein the stand has only one vertical leg 15, which can be displaced along the carrier 2 or the operating-table, so that accessibility to the surgeon is improved. As apparent from FIG. 3 and FIG. 5 the strap 5 can alternatively be attached to the carrier 2.

The hip cushion 8, either divided in two or being single one should in all cases have such an extension sidewise, that is across the longitudinal direction of the operating-table, that the patient is lying stable in lateral decubitis position and can not fall over either on the back or on the abdominal side.

The orientation of the pelvis in the longitudinal direction of the operating-table is also important and for this purpose, when the patient is covered with operating-cloths and position of the pelvis is difficult to control, a direction indicator can be arranged, such as a rod, in a holder on the upper hip cushion, or on the stand, whereby the direction indicator is stitched through said operating-cloths. The direction indicator can then cooperate with a direction Indicator used in the cup-inserter shown in PCT/SE00/01474.

As evident from the description above in connection with FIG. 1-6 the abdomen is free in all the embodiments which facilitates breathing and thereby the risk for other discomfort including feelings of sickness.

To sum up, the invention accordingly gives a more stable and more safe fixation of the patient by means of the vertical support; large abdominal volume does not make the positioning and fixation more difficult; discomfort, effects on the breathing and risk of vomiting are avoided thanks to the fact that no pressure is exerted against the abdomen; by applying formable cushions, such as vacuum cushions, the pressure from the fixation is distributed over a large surface, which in turn eliminates the risk of pressure ulcers; by not covering the patients abdomen by the fixation the patient's pelvis can be measured in with great accuracy in an exact vertical position by means of a libel; and the arrangement can, in a simple way, be used on existing surgical operating-tables.

1. An arrangement for fixation of a patient prior to a surgical operation, like hip joint surgery, comprising support units applied against a pelvis wherein at least one support unit comprises a support/compression applicable across the pelvis, when the pelvis is placed in a lateral decubitis position for exerting a vertically applied pressure (vertical power).

2. An arrangement according to claim 1, wherein the support comprises at least one hip cushion applicable against the lateral part of the pelvis arranged to be stretch in vertical direction against a pelvis.

3. An arrangement according to claim 1, wherein the support comprises a lower and an upper hip cushion.

4. An arrangement according to claim 3, wherein the lower hip cushion is divided into two parts, which two parts are arranged displaceably relative to each other.

5. An arrangement according to claim 1, wherein a vertically displaceable, fixable stand is arranged to give a vertical, applied support/compression across the pelvis, when the pelvis is in a lateral decubitis position.

6. An arrangement according to claim 5, wherein the vertically displaceable stand comprises an intermediate part arranged to abut to the upper hip cushion.

7. An arrangement according to claim 6, wherein said intermediate part is bent at an angle.

8. An arrangement according to claim 6, wherein the vertically displaceable stand comprises two fixed legs.

9. An arrangement according to claim 1, wherein the vertically operating support units are arranged to be stretched against the pelvis by means of at least one strap.

10. An arrangement according to claim 1, wherein the arrangement is arranged to a carrier arranged to be fixed to an operating-table.

11. An arrangement according to claim 1, wherein the hip cushion consists of a polyurethane foam material cushion.

12. An arrangement according to claim 1, wherein the hip cushion consists of a vacuum cushion.

13. An arrangement according to claim 12, wherein the vacuum cushion is arranged to run from the lower part of the pelvis in lateral decubitis position to the upper part via the lumbar region.

14. A method for positioning of a patient prior to a surgical operation for vertical positioning of said patients pelvis, at which a vertical pressure is applied across to the pelvis, when the pelvis is in a lateral decubitis position.

15. A method of claim 14, wherein at least one support in form of a hip cushion is applied against the patients iliac.

16. A method of claim 15, wherein at least one vertically displaceable, fixable means is arranged to exert said vertical pressure.

17. A method of claim 14, wherein at least one strap is arranged to provide said vertical pressure.
